(19) United States
(12) Patent Application Publication
(10) Pub. No.: US 2009/0049466 A1
(43) Pub. Date: Feb. 19, 2009

(54) Using Utility Outlets to Determine and Report Media-Based Activity

(75) Inventors: Roland Schoettle, Freeport (BS); Charles Tuckey, Raleigh, NC (US)

Correspondence Address: FULBRIGHT & JAWORSKI L.L.P, 2200 ROSS AVENUE, SUITE 2800, DALLAS, TX, 75201-2784, US

(73) Assignee: Optimal Innovations Inc., Bridgetown (BB)

(21) Appl. No.: 12/193,589

(22) Filed: Aug. 18, 2008

Related U.S. Application Data
(60) Provisional application No. 60/956,306, filed on Aug. 16, 2007.

(51) Int. Cl. H04H 60/32

(52) U.S. Cl. 725/14

(57) ABSTRACT

Utility outlets such as light switches, power sockets and permanently mounted light sockets for detecting, measuring and reporting user parameters and/or media based activity in a premises. System and methods for measuring media activity in a premises using utility outlets.

### CROSS-REFERENCE TO RELATED APPLICATIONS

This application claims priority from U.S. Provisional Patent Application No. 60/956,306, entitled “USING UTILITY OUTLETS TO DETERMINE AND REPORT MEDIA-BASED ACTIVITY” and filed Aug. 16, 2007, the disclosure of which is hereby incorporated herein by reference. The present application is related to co-pending, and commonly assigned U.S. patent application Ser. No. 10/094,743, Attorney Docket No. 74268/P005US/10506911, entitled “HYBRID FIBER/CONDUCTOR INTEGRATED COMMUNICATION NETWORKS;” U.S. patent application Ser. No. 11/512,742, Attorney Docket No. 74268/P008US/10606747, entitled “HYBRID FIBER/CONDUCTOR INTEGRATED COMMUNICATION NETWORKS;” U.S. patent application Ser. No. 11/683,304, Attorney Docket No. 74268/P012US/10609934, entitled “SYSTEMS AND METHODS FOR LINKING UTILITY CONTROL DEVICES;” U.S. patent application Ser. No. 11/683,327, Attorney Docket No. 74268/P013US/10609935, entitled “SYSTEM AND METHOD FOR INFRASTRUCTURE REPORTING;” U.S. patent application Ser. No. 11/683,298, Attorney Docket No. 74268/P014US/10614006, entitled “LIGHT SWITCH USED AS A COMMUNICATION DEVICE;” U.S. patent application Ser. No. 11/683,308, Attorney Docket No. 74268/P015US/10614005, entitled “SYSTEM AND METHOD FOR PREMISES MONITORING USING WEIGHT DETECTION;” U.S. patent application Ser. No. 11/923,176, Attorney Docket No. 74268/P015CP1/10704955, entitled “SELF LEARNING AUTOMATION SYSTEM;” U.S. patent application Ser. No. 11/683,326, Attorney Docket No. 74268/P016US/10614296, entitled “ANTICIPATORY UTILITY CONTROL DEVICE;” U.S. patent application No. ______, Attorney Docket No. 74268/P016CP1/10704956, entitled “ANOMALY-BASED PREMISE CONTROL;” U.S. patent application Ser. No. 11/683,335, Attorney Docket No. 74268/P017US/10614295, entitled “PLUG AND PLAY UTILITY CONTROL MODULES;” U.S. Patent Application No. 60/956,279, Attorney Docket No. 74268/V022.0/10712693, entitled “UTILITY OUTLETS CAPABLE OF PRESENTING IMAGES;” U.S. patent application Ser. No. 11/683,354, Attorney Docket No. 74268/P025US/10704959, entitled “LIGHT SWITCH POWER SUPPLY;” U.S. Patent Application No. 60/956,314, Attorney Docket No. 74268/V026.0/10712694, entitled “UTILITY OUTLETS AS A SECURITY SYSTEM;” U.S. Patent Application No. 60/940,010, Attorney Docket No. 74268/V027.0/10706725, entitled “LIGHT SWITCH AS A SECURITY HUB;” U.S. Patent Application No. 60/940,015, Attorney Docket No. 74268/V028.0/10706810, entitled “UTILITY OUTLETS AS REMOTE CONTROL REPEATERS;” U.S. patent application Ser. No. ______, Attorney Docket No. 74268/P029US/10704963, entitled “TEMPERATURE DETECTIONS AND CALCULATIONS OUTLETS,” the disclosures of which are hereby incorporated herein by reference.

### TECHNICAL FIELD

The current invention relates to utility outlets and specifically the use of utility outlets to detect and report media based activity.

### BACKGROUND OF THE INVENTION

Generally, consumers receive media from a wide variety of sources that deliver various media types, including internet, radio, and television media programming in bulk. For example, television programming is typically purchased by paying a fee to view a channel or a bundle of channels. For at least two reasons, a consumer who receives a channel or bundle of channels may only consume, regularly, a portion of that which is available. First, the consumer may view only some of the channels available. Second, the consumer is likely to view only certain programs on those viewed channels. Consequently, it is not possible to measure consumption of products in the media industry by what is made available as is done in other industries. In other words, the size of the viewing audience for a particular program cannot be determined by what is made available. For example, where television programming is purchased, the size of the viewing audience for a particular program cannot be determined by actual sales. For this reason, there are companies that track audience size by various means including, measuring the number of “hits” experienced by internet media, conducting interviews and installing devices on television sets of viewers and radio sets of listeners.

With regard to the installation of devices on television sets, however, a company that measures audience size has to get the agreement from a user to install the measuring device in the user's home. After the user and the company have reached an agreement, then the company arranges to have the device installed in the user's premises. There exists a need, therefore, for a way to measure the audience size for a program without having to install a stand-alone-device having the sole function of measuring media activity. Additionally, with the rapid development of technology, people are increasingly relying on several devices to consume programs and to access information. For example, devices such as computers, Personal Digital Assistants (PDAs), cellular phones and other such wireless devices now carry media via the Internet that a person would traditionally access by a television set. Thus, the conventional measuring device attached to a television set cannot measure media activity taking place via contemporary devices such as cellular phones, PDAs, computers, etc.

### BRIEF SUMMARY OF THE INVENTION

In this application, media activity means communications delivered electronically. Measuring media activity includes keeping a record of the media consumed and the period the media is consumed. Measuring user parameters includes any of recording/storing the user parameters and determining/recording the user associated with a user parameter. The present invention is directed to products, systems and methods that measure the media consumed within a premises. Specifically, embodiments of the current invention involve the use of utility outlets to measure media activity and/or user parameters within the premises. Typically, where there is media activity within a premises, there are utility outlets such as power sockets, light switches and mounted light sockets. Consequently, the use of utility outlets to detect, record and transmit media activity and/or user parameters, avoids the need to have stand alone devices in a premises to do so. Furthermore, because embodiments of the current invention takes advantage of the increasing use of wireless technology and remote control signals, the current invention provides a way to detect and report media activity occurring on several devices in a premises.

In one embodiment, the utility outlets contain occupancy sensors and discriminating cameras that can sense the number of users and can determine if the users are children or adults. In yet another embodiment the utility devices contain the ability to read user parameters that are stored on cellular handsets, key fobs, and other electronic devices that contain user information. Consequently, in another embodiment of the invention, the utility outlets may be used to determine the number of users consuming a measured media activity.

Embodiments of the invention may involve any type of media activity such as all audio and video systems as well as all systems that can deliver audible, visual and other sensory based information, e.g., computers, display panels, and so on. In one embodiment, a gateway device is the device through which all media, including Internet media, standard TV, IP TV, HD TV, Radio, blogs, audio, music, telepresence, telephone, etc. enters the premises. The operation of this gateway device is disclosed in U.S. patent application Ser. No. 11/683,354 filed on Mar. 7, 2007 entitled “SYSTEM AND METHOD FOR SUBSTITUTING DATA IN RESPONSES TO MULTIMEDIA INQUIRIES,” and U.S. patent application Ser. No. 11/696,625 filed Apr. 4, 2007 entitled “SYSTEM AND METHOD FOR INCREASING THE EFFICIENCY IN THE DELIVERY OF MEDIA WITHIN A NETWORK,” the disclosures of which are incorporated herein by reference. In the embodiment where the gateway device is the device through which all media enters the premises, the gateway device could be used to determine/measure what the media is, where the media is going in the premises, and who and how many locations or persons the media is going to.

In another embodiment of the invention, the measured media activity could be presented to parents who would use this information to determine what a child watches on television or their computer. The parents could then act to change channels or turn off power to the device.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawing, in which:

FIG. 1 is one embodiment of the current invention illustrating a power socket.

FIG. 2 is another embodiment of the current invention including a plurality of utility outlets.

### DETAILED DESCRIPTION OF THE INVENTION

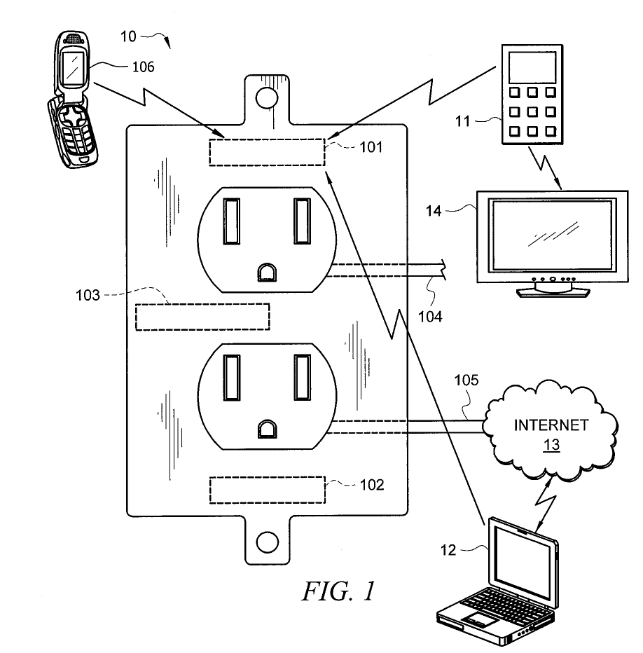

FIG. 1 illustrates one embodiment 10 of the current invention. Utility outlet 10 is a power socket used in a premises to allow devices to connect to electrical power via cable 104. Power socket 10 includes a receiver 101 which is capable of receiving signals such as remote control signals from a sender device 11, a wireless signal from computer 12, an occupancy signal, a discriminating camera, and/or a wireless signal from a cellular phone or key fob. Utility outlet 10 also includes processor 102. Processor 102 is programmed to determine and measure, based on the signals received by receiver 101, the media activity on the device being controlled by sender device 11. For example, if a user changes the channel on television set 14 using the sender device 11, utility outlet 10 located in proximity to television set 14 would receive that signal via receiver 101. Processor 102, if desired, is capable of allowing a user to preprogram utility outlet 10 to identify a particular remote control signal code with a particular channel. Processor 102 would then use the code of the remote control signal to determine the program being viewed on television 14. Processor 102, which has an internal clock (not shown), can record the periods a particular channel is viewed based on the power on, power off and channel switching remote control signals from sender device 11.

Another example of an embodiment of the current invention involves the scenario where a computer 12 is in wireless communication with Internet 13. Receiver 101 receives signals sent by computer 12. Receiver 101 is connected to processor 102. The wireless signals from computer 12 are processed by processor 102 and thus, the Internet sites visited or the programs viewed via the Internet 13 and applicable times are recorded by processor 102.

Utility outlet 10 may also include a transmitter 103, connected to processor 102, for transmitting to another device, the media activity recorded by processor 102. The transmission may be done by cable, wirelessly, or a combination thereof. In one embodiment, the utility outlet transmits the media activity via power cable 104 to an interconnected device. Alternatively, media activity may be transmitted via communication cable 105 to Internet 13 and then from Internet 13 to another device. If desired, one utility outlet may be responsible for receiving and collating all the media activity in a premises and sending the collated media activity for the premises to a remote device.

In one embodiment of the invention, media activity is measured in a premises having electrical power, where the embodiment comprises detecting and measuring the media activity in the premises using at least one of a plurality of utility outlets 10. Utility outlets 10 may be a power socket, an electrical switch or a permanently mounted light socket. Utility outlets 10 may be interconnected in the premises by power cable 104. After at least one of utility outlets 10 detects and measures the media activity, utility outlet 10 may transmit the measured activity by, for example, communication cable 105 to an electronic network 13. Alternatively, transmission may be by power cable 104, which connects the plurality of utility outlets in the premises. A different utility outlet 10 (or possibly some other device) receives (via electronic network 13 or power cable 104) and collates the transmitted media activity from all of the utility outlets 10 of the premises to a remote device. The transmission of the collated media activity may be, for example, by power cable 104, communication cable 105 and network 13 or wirelessly.

In another embodiment of the invention, user activity is measured in proximity with the utility outlet, where the embodiment comprises detecting and measuring the user activity where utility outlet 10 may also include a receiver 101, connected to processor 102, for receiving, from another device, the user parameters from wireless devices recorded by processor 102. Processor 102 may be capable of determining the user associated with the user parameters. The receiving function may be done by cable, wirelessly, or a combination thereof. In one embodiment, the utility outlet receives the user activity via receiver from a cellular phone device. Alternatively, user parameters activity may be received and sent via communication cable 105 to and from Internet 13 and then to and from Internet 13 to another device. If desired, one utility outlet may be responsible for receiving, collating, and sending all the media activity in a premises and sending or receiving the collated media activity for the premises to or from a remote device.

Because receiver 101 may detect the user parameters of electronic devices in proximity to utility outlet 10, utility outlet 101 may be able to detect that cellular phone 106 is in proximity to utility outlet 101 and the user parameters applicable to cellular phone 106. In detecting that cellular phone 106 is in proximity to utility outlet 10 and identifying the user parameters associated to cellular phone 106, utility outlet 10 can identify which individual is consuming media activity on say television 14 if television 14 is detected as transmitting media activity while cellular phone 106 is in proximity to utility outlet 10. The assumption here is that a user will always carry his or her cellular phone wherever he or she goes. Further, because utility outlet 101 can identify individuals consuming a particular media activity, utility outlet 10 can also determine how many persons are consuming a particular media activity.

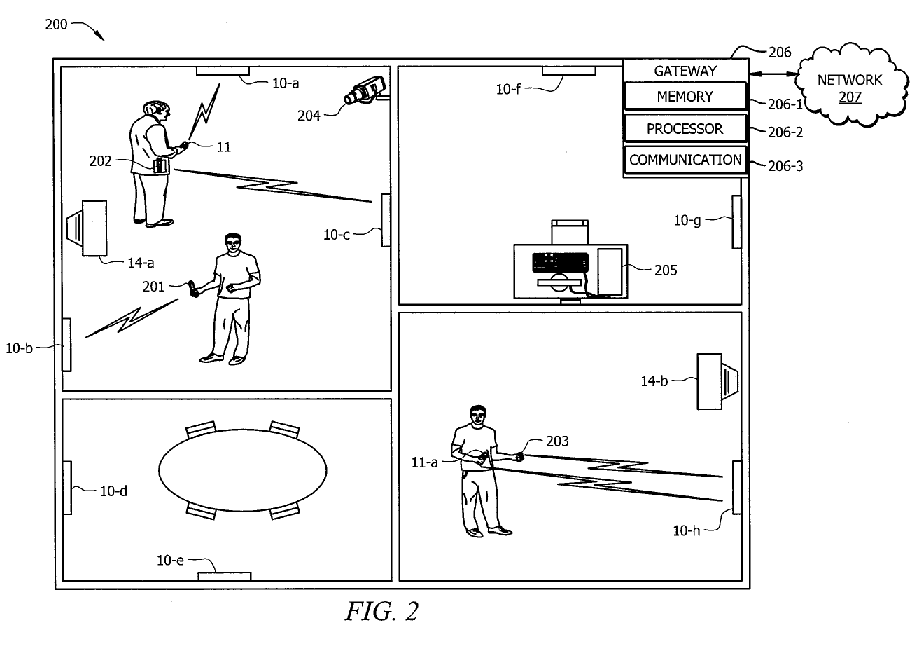

FIG. 2 illustrates another embodiment of the current invention. Premises 200 has a plurality of utility outlets 10-a to 10-h interconnected by cable 105 or wirelessly. Utility outlets 10-a to 10-c are capable of detecting, based on remote control signals from remote controller 11, the media activity presented on television 14-a. Utility outlet 10 can also determine the number of persons and which persons are in proximity to television 14-a. In other words, the system can determine the identity of the person or persons who are consuming media activity on television 14. Utility outlets 10-a to 10-c determine the number of persons by identifying the parameters of personal electronic devices such as cellular phone 201 and personal key fob 202, based on wireless signals from these devices. Accordingly, the plurality of utility outlets 10-a to 10-c identifies that the media activity on television 14-a is being consumed by at least two persons. Similarly, in another room in premises 200, utility outlet 10-h is capable of determining at least one person is consuming media activity on television 14-b based on signals from remote controller 11-a and PDA 203.

Identifying the number of people consuming media activity at a particular time may also involve identifying who is in proximity to television 14-a by use of camera 203 or utility outlet 10-a equipped with motion detection technology. In one embodiment, utility outlet 10-a includes camera 203. Motion detection technology may be installed, for example, for detecting motion at different heights so that the number of people (assuming they have different heights) may be identified. In one embodiment, the motion detection device may be installed in utility outlet 10-a. Embodiments of the invention may use any of these methods of determining the amount of persons in proximity to a device such as television 14-a. It should be noted that the different methods of determining the amount of persons in proximity to a device may be used alone or in combination.

The data collected regarding the media activity presented in premises 200 and the number of persons or which persons consumed such media activity may be transmitted to one device such as device 10-g or gateway 206. Transmission may be by communication cable 105, cable power cable 104, wirelessly or by other means. Device 10-g may collate this information and send it, for example, to PC 205 where the media activity may be reviewed by the parents occupying premises 200. Alternatively device 10-g may transmit the collated data to another device, for example, the device of a company that does Nielsen's ratings or other such ratings. In some embodiments the data need not be collated on premises 200 but is transmitted from utility outlets 10-a to 10-h to a remote device.

In one embodiment, the measuring of the media activity is carried out by a gateway 206. All media received in premises 200 passes through gateway 206. For example, all media from network 207 passes through gateway 206 destined for devices in premises 200 such as television 14-a and 14-b. As such, gateway 206 is capable of measuring the media activity being consumed at any of the devices 14-a and 14-b. In this embodiment, the plurality of utility outlets may be used to detect the number of users consuming media activity, for example, media activity presented by 14-a and 14-b. In one embodiment of the present invention, the measured media activity and measured user parameters may be used for billing purposes by the supplier of media activity, i.e. payment based on the amount of persons consuming the media activity. Additionally, consumers may use the media activity and user parameters data to optimize their media purchasing by looking at their consumption patterns.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A utility outlet for use in connecting to a premises' electrical power and measuring media activity in said premises, said utility outlet comprising:
means for connecting electrical devices to said premises' electrical power;
means for detecting said media activity in said premises; and
means for measuring said detected media activity.

2. The utility outlet of claim 1 wherein said utility outlet is one of a group consisting of:
a power socket, an electrical switch, a permanently mounted light socket.

3. The utility outlet of claim 1 further comprising:
means for transmitting measured media activity from said premises' utility outlets.

4. The utility outlet of claim 3 further comprising:
means for connecting said utility outlet to an electronic network.

5. The utility outlet of claim 3 further comprising:
means for receiving and collating measured media activity from said premises' utility outlets.

6. The utility outlet of claim 1 wherein said media activity is detected from at least one of the group consisting of:
a remote control signal, a wireless signal, a power signal, a communications signal.

7. A method for measuring media activity in a premises having electrical power, said method comprising:
detecting said media activity in said premises using at least one of a plurality of utility outlets; and
measuring said media activity in said premises using at least one of said utility outlets, wherein said utility outlets are capable of connecting an electrical device to said premises' electrical power.

8. The method of claim 7 wherein said utility outlets are selected from a group consisting of:
a power socket, an electrical switch, a permanently mounted light socket.

9. The method of claim 7 further comprising:
transmitting said measured media activity.

10. The method of claim 9 wherein at least one of said utility outlets is connected to an electronic network.

11. The method of claim 9 further comprising:
receiving and collating measured media activity from said premises' utility outlets.

12. The method of claim 10 wherein said media activity is detected from at least one of the group consisting of:
a remote control signal, a wireless signal, a power signal, a communications signal.

13. A system for measuring media activity within a premises having electrical power, said system comprising:
a plurality of utility outlets, wherein said plurality of utility outlets comprises:
means for connecting electrical devices to said premises' electrical power;
means for detecting media activity within said premises; and
means for measuring said media activity within said premises.

14. The system of claim 13 wherein said plurality of utility outlets is selected from a group consisting of:
a power socket, an electrical switch, a permanently mounted light socket.

15. The system of claim 13 further comprising:
means for transmitting said measured media activity.

16. The system of claim 15 wherein at least one of said plurality of utility outlets is connected by cable to an electronic network.

17. The system of claim 15 wherein at least one of said plurality of outlets is capable of receiving and collating measured media activity from said premises' utility outlets.

18. The system of claim 13 wherein said media are detected from at least one of the group consisting of:
a remote control signal, a wireless signal, a power signal, a communications signal.

19. A utility outlet for use in connecting to a premises' electrical power, said utility outlet comprising:
a first set of terminals for connecting said utility outlet to said premises' electrical power;
a receiver for receiving a signal from a sending device; and
a processor connected to said receiver and operable for measuring media activity based on said received signal.

20. The utility outlet of claim 19 wherein said utility outlet is one of a group consisting of:
a power socket, an electrical switch, a permanently mounted light socket.

21. The utility outlet of claim 19 further comprising:
a transmitter.

22. The utility outlet of claim 21 further comprising:
a second set of terminals for connecting said utility outlet to an electronic network.

23. The utility outlet of claim 21 wherein said receiver is capable of receiving measured media activity from other outlets and said processor is capable of collating measured media activity of said premises' utility outlets.

24. The utility outlet of claim 19 wherein said signal is selected from at least one of the group consisting of:
a remote control signal, a wireless signal.

25. A utility outlet for use in connecting to a premises' electrical power and measuring user parameters in said premises, said utility outlet comprising:
means for connecting electrical devices to said premises' electrical power;
means for detecting said user parameters in said premises; and
means for measuring said user parameter.

26. The utility outlet of claim 25 wherein said utility outlet is one of a group consisting of:
a power socket, an electrical switch, a permanently mounted light socket.

27. The utility outlet of claim 25 further comprising:
means for transmitting measured user parameters from said premises' utility outlets.

28. The utility outlet of claim 25 further comprising:
means of sending said measured user parameters.

29. The utility outlet of claim 27 further comprising:
means for connecting said utility outlet to an electronic network.

30. The utility outlet of claim 27 further comprising:
means for receiving and collating measured user parameters from said premises' utility outlets.

31. The utility outlet of claim 25 wherein said user parameters are detected from at least one of the group consisting of:
a remote control signal, a wireless signal, a power signal, a communications signal.

32. A method for measuring user parameters of a personal electronic device in a premises having electrical power, said method comprising:
detecting said user parameters in said premises using at least one of a plurality of utility outlets; and
measuring said user parameters in said premises using at least one of said utility outlets, wherein said utility outlets are capable of connecting an electrical device to said premises' electrical power.

33. The method of claim 32 wherein said utility outlets are selected from a group consisting of:
a power socket, an electrical switch, a permanently mounted light socket.

34. The method of claim 32 further comprising:
transmitting said measured user parameters.

35. The method of claim 34 wherein at least one of said utility outlets is connected to an electronic network.

36. The method of claim 34 further comprising:
receiving and collating measured user parameters from said premises' utility outlets.

37. The method of claim 35 wherein said user parameters is detected from at least one of the group consisting of:
a remote control signal, a wireless signal, a power signal, a communications signal.

38. The method of claim 32 wherein said measuring user parameters includes a selection from the list:
recording user parameters, storing user parameters, determining a user associated with a user parameter, recording a user associated with a user parameter.

39. The method of claim 32 wherein said determining of a user comprises associating the user parameters of said personal electronic device to said user.

40. A system for measuring user parameters within a premises having electrical power, said system comprising:
a plurality of utility outlets, wherein said plurality of utility outlets comprises:
means for connecting electrical devices to said premises' electrical power;
means for detecting user parameters within said premises; and
means for measuring said user parameters within said premises.

41. The system of claim 40 wherein said plurality of utility outlets is selected from a group consisting of:
a power socket, an electrical switch, a permanently mounted light socket.

42. The system of claim 40 further comprising:
means for receiving said measured user parameters.

43. The system of claim 40 further comprising:
means for transmitting said measured user parameters.

44. The system of claim 43 wherein at least one of said plurality of utility outlets is connected by cable to an electronic network.

45. The system of claim 43 wherein at least one of said plurality of outlets is capable of receiving and collating measured user parameters from said premises' utility outlets.

46. The system of claim 40 wherein said user parameters are detected from at least one of the group consisting of:
a remote control signal, a wireless signal, a power signal, a communications signal.

47. A utility outlet for use in connecting to a premises' electrical power, said utility outlet comprising:
a first set of terminals for connecting said utility outlet to said premises' electrical power;
a receiver for receiving a signal from a sending device; and
a processor connected to said receiver and operable for measuring user parameters based on said received signal.

48. The utility outlet of claim 47 wherein said utility outlet is one of a group consisting of:
a power socket, an electrical switch, a permanently mounted light socket.

49. The utility outlet of claim 47 further comprising:
a transmitter.

50. The utility outlet of claim 49 further comprising:
a second set of terminals for connecting said utility outlet to an electronic network.

51. The utility outlet of claim 49 wherein said receiver is capable of receiving measured user parameters from other outlets and said processor is capable of collating measured user parameters of said premises' utility outlets.

52. The utility outlet of claim 49 wherein said transmitter is capable of transmitting measured user parameters from other outlets and said processor is capable of collating measured user parameters of said premises' utility outlets.

53. The utility outlet of claim 49 wherein said signal is selected from at least one of the group consisting of:
a remote control signal, a wireless signal, a power signal, a communications signal.

54. A system for measuring media activity within a premises having electrical power, said system comprising:
a gateway, said gateway adapted to distribute media from a network to a plurality of devices in a premises;
a plurality of utility outlets, wherein said plurality of utility outlets comprises:
means for connecting electrical devices to said premises' electrical power;
means for detecting user parameters within said premises; and
means for measuring said user parameters within said premises.
